(19) United States
(12) Patent Application Publication
(10) Pub. No.: US 2011/0140592 A1
(43) Pub. Date: Jun. 16, 2011

(54) LIGHT-EMITTING SUBSTRATE, MANUFACTURING METHOD THEREOF, AND ELECTRON-BEAM EXCITATION IMAGE DISPLAY APPARATUS USING LIGHT-EMITTING SUBSTRATE

(75) Inventors: Kazunori Sano, Yokohama-shi (JP); Daisuke Sasaguri, Yokohama-shi (JP)

(73) Assignee: CANON KABUSHIKI KAISHA, Tokyo (JP)

(21) Appl. No.: 12/963,947

(22) Filed: Dec. 9, 2010

(30) Foreign Application Priority Data
Dec. 16, 2009 (JP) 2009-285199

(51) Int. Cl. H01J 1/70; H01J 9/00

(52) U.S. Cl. 313/483; 445/23

(57) ABSTRACT

A phosphor having the lowest E/L ratio of the luminance (L) to the luminous efficiency (E) of each phosphor for obtaining a target chromaticity of white using a plurality of phosphors which emit different colors on a light-emitting substrate is selected, and the light reflectance of the portion of the metal back layer formed on this phosphor is set to be higher than the portion formed on the other phosphors.

### BACKGROUND OF THE INVENTION

1. Field of the Invention

The present invention relates to a light-emitting substrate which can be suitably used for constructing an image display surface of an electron-beam excitation type image display apparatus, a manufacturing method thereof, and an image display apparatus using this light-emitting substrate.

2. Description of the Related Art

As image information becomes more diversified and high-resolution today, higher performance, larger size and further improvements in image appearance are demanded for color image display apparatuses. Demand for energy saving and space saving features are especially high. As a result, demand in the field of electron-beam excitation type image display apparatuses is shifting from a cathode ray tube (CRT), known as the Braun tube, to a flat panel display (FPD).

An example of an FPD is a field emission display (FED). An FED is an image display apparatus in which the same number of micro-electron-emitting devices as the number of pixels are disposed on a substrate, and which displays images by emitting electrons from the electron-emitting devices into a vacuum, so that electrons collide with phosphor and emit light. The electron-emitting device corresponds to the electron gun of the Braun tube. An FED can implement a bright and high contrast screen, similar to a CRT, as a large flat panel display, and is expected as a next generation self-emission type FPD.

There are two types of FEDs: a type that uses an electron-emitting device called a “Spindt type” which emits electron beams from the tip of a cone-shaped emitter; and a type that uses a flat structured electron-emitting device called a “Surface-Conduction Electron-emitter (SCE)”. An FED that uses SCE as an electron-emitting device is called a “Surface-condition Electron-emitter Display (SED)”.

In an FED, in order to use emission of phosphor efficiently, a metal layer (or metal film) called a “metal back” is formed on the top of pixels in which phosphor is disposed. By the metal back, light scattered in a direction not toward the image display surface can be reflected to the image display surface side, so the luminous efficiency of the pixels as a whole improves. Parameters which determine the performance of the metal back include light reflectance, surface roughness and electron beam transmittance of the metal back.

As methods for obtaining a smooth metal back layer to improve the light reflectance on the metal back toward the phosphor area side, the following two methods are normally used for a CRT substrate. One is coating resin emulsion on the phosphor constituting the pixels, so as to form an underlayer to smooth the metal back layer, forming the metal back on this underlayer. The other is forming a water film on the phosphor, supplying a solution of resin being dissolved in solvent to the water film, forming a resin film as an underlayer for smoothing the metal back layer by drying, and then forming the metal back layer.

Japanese Patent Application Laid-Open No. H5-109357 discloses a method of forming a CRT aluminum back undercoat film, in which the aluminum back undercoat film is formed, after forming the pre-treatment agent for forming the water film to be equal to or thinner than the thickness of the phosphor. Japanese Patent Application Laid-Open No. H6-131988 discloses a method of smoothing a surface on which a metal back layer of the phosphor is disposed on the panel surface for the CRT, by constituting the phosphor by two layers, where the particle diameter of the phosphor is smaller in the second layer than in the first layer.

### SUMMARY OF THE INVENTION

In the case of a color image display of an HDTV (High Definition TeleVision), red, green, blue (hereafter may be abbreviated as R, G and B) and white (hereafter may be abbreviated as W) are defined as following by CIE chromaticity coordinates.

R: (x, y)=(0.64, 0.33)
G: (x, y)=(0.3, 0.6)
B: (x, y)=(0.15, 0.06)
W: (x, y)=(0.3127, 0.329) (hereafter (0.313, 0.329))
W here is the chromaticity of white, which is generated when the phosphors of all colors are emitted.

If the phosphors for R, G and B, that satisfy the chromaticity for displaying images, are formed on a substrate, the luminous efficiency of each phosphor is normally different. Therefore the luminous efficiency ratio is determined among each phosphor for R, G and B, and a range of luminance (brightness) obtained by each phosphor having different luminous efficiency, such as a maximum luminance to be obtained in each phosphor, also becomes different. In order to display white using these phosphors, the luminance of each phosphor must be combined (white balance) to obtain white having a reference chromaticity. In an image display apparatus, white balance is performed by adjusting such that the luminance of white becomes the highest, and the intended white (chromaticity) color is developed. Since luminous efficiency of the phosphor itself cannot be increased in a state of being disposed on the light-emitting substrate, the luminance of a color selected from R, G and B is adjusted for white balance.

The luminance when white having a reference chromaticity (also called “full white”) is emitted, with maintaining a white balance, is called “full white luminance”. A possible method to increase the maximum value of the full white luminance is obtaining a white having a target chromaticity not by decreasing the maximum luminance of the phosphor having the lowest ratio (E/L ratio) of luminous efficiency (E) to luminance (L), required for obtaining white having the target chromaticity, but by decreasing the maximum luminance of phosphors of the other colors.

For this, the full white luminance when full white is emitted by the three colors, R, G and B, is limited by the luminous efficiency of the phosphor having the lowest E/L ratio.

The above description is about a case of using the phosphors of three colors, R, G and B, but the same is true even if a number of phosphor types is two or four or more.

It is an object of the present invention to increase the full white luminance and to provide a light-emitting substrate having a structure suitable for obtaining the full white, and a manufacturing method thereof. It is another object of the present invention to provide an image display apparatus using this light-emitting substrate.

The present invention in its first aspect provides a light-emitting substrate, comprising on a light transmissive substrate: a plurality of phosphors which emit different colors by receiving an irradiated electron beam; and a metal back layer covering these phosphors, wherein white can be generated by different colors obtained by the emission of the phosphors, and a light reflectance difference is created by setting a reflectance, on the phosphor side, of the metal back layer on a phosphor having a lowest E/L ratio, which is a ratio of luminance (L) and luminous efficiency (E) when white is generated, to be higher than those of the metal back layer on the other phosphors.

The present invention in its second aspect provides an electron-beam excitation image display apparatus, comprising: a rear plate having a plurality of electron-emitting devices; and a face plate on which phosphors, which emit light by irradiation of electrons emitted from the electron-emitting devices, are disposed, wherein the face plate is the light-emitting substrate.

The present invention in its third aspect provides a method of manufacturing a light-emitting substrate which has, on a light transmissive substrate, a plurality of phosphors which emit different colors by receiving irradiated electrons, and a metal back layer covering these phosphors, and can generate white by different colors from the plurality of phosphors, the method comprising steps of: forming a plurality of phosphors for emitting different colors which can generate white on the light transmissive substrate; filling a resin member in a surface of a phosphor having a lowest E/L ratio, which is a ratio of the luminance (L) and luminous efficiency (E) when white is generated so as to smooth the surface; and

forming a metal back layer for coating the plurality of phosphors including the phosphor in which the resin member is filled, wherein in the step of filling the resin member in the surface of the phosphor having the lowest E/L ratio for smoothing the surface, fluorescent material layer of the phosphor having the lowest E/L ratio is formed so that thickness thereof is less than that of the other phosphors, and the resin member is filled down to the surface of the fluorescent material layer of the phosphor having the lowest E/L ratio, whereby the surface of the phosphor having the lowest E/L ratio becomes smoother than the surface of the other phosphors, and a light reflectance difference is created so that a light reflectance of the metal back layer on the phosphor having the lowest E/L ratio on the phosphor side is higher than those of the metal back layer on the other phosphors.

According to the light-emitting substrate of the present invention, a light reflectance difference is set since the light reflectance of the metal back layer on the phosphor having the lowest ratio (E/L) of the luminous efficiency (E) and luminance (L) for performing white balance, to the phosphor side, is higher than those of the other phosphors. Because of the structure having this light reflectance difference, chromaticity of white can be accurately adjusted, and the maximum value of the full white luminance can be increased, therefore an image can be displayed with target luminance and image quality.

Further features of the present invention will become apparent from the following description of exemplary embodiments with reference to the attached drawings.

### BRIEF DESCRIPTION OF THE DRAWINGS

FIG. 1A is a plan view of a light-emitting substrate, and FIG. 1B is an X-X cross-sectional view of the light-emitting substrate; and

FIG. 2 is a diagram depicting a structure of an image display apparatus.

### DESCRIPTION OF THE EMBODIMENTS

A light-emitting substrate has at least a light transmissive substrate constituting an image display surface, a plurality of phosphors which emit different colors, and a metal back layer which covers the phosphors. The phosphors on the substrate are disposed on a plane, and the substrate surface opposite of the surface where the phosphors are disposed becomes the image display surface. Energy, such as an electron beam, is irradiated onto the phosphors of the light-emitting substrate for emission, and obtained light is extracted to the image display surface side via the light transmissive substrate to display the image. This light-emitting substrate is suitably used as a component of the image display portion (display panel) of an image display apparatus which displays an image by the emission of the phosphor layer. This is especially suitable for an FED.

In the light-emitting substrate of the present invention, the phosphor side light reflectance of the metal back layer, which covers the phosphor having the lowest E/L ratio, is set to be higher than those of the metal back layer covering other phosphors, so that a partial light reflectance difference is created in the metal back layer. The E/L ratio is a ratio of the luminance (L) and the luminous efficiency (E) when white is displayed using a plurality of different colors. By creating the above mentioned light reflectance difference in the metal back layer, the luminous efficiency of the phosphor layer, of which E/L ratio is the lowest, can be increased so as to increase the maximum luminance of this phosphor. The other phosphors originally have high luminous efficiency, and the upper limit (maximum value) of the luminance thereof is limited to low when full white is displayed. Therefore by increasing the maximum luminance of the phosphor having the lowest E/L ratio, using the above mentioned configuration of creating a light reflectance difference, the maximum luminance of the other phosphors can be increased as well. As a result, the maximum value of the full white luminance can be increased. Furthermore the luminance of each phosphor, to display full white, can be adjusted accurately by both the structure of setting the light reflectance difference and the drive conditions to adjust electron beam dosage.

The luminance of each phosphor to display white is specified according to the chromaticity of the phosphor. The luminous efficiency of the phosphor itself is specified depending on the fluorescent material constituting the phosphor and structure of the phosphor. The above mentioned E/L ratio can be determined using the luminance (L) and luminous efficiency (E) obtained based on these requirements. The E/L ratio may be determined based on measured values by forming phosphors as a sample for measuring luminance.

The luminous efficiency can be calculated by measuring the luminance which is emitted when an electron beam is irradiated onto the phosphor. The luminance can be measured by irradiating an electron beam onto a glass substrate on which phosphor is formed, and measuring the light emitted to the glass surface using a spectral radiance meter, for example.

The colors can also be displayed by a combination of two complimentary colors, such as red and cyan, or yellow and purple. In order to improve color reproducibility, color display is normally performed using three colors: red (R), green (G) and blue (B). In some cases, color reproducibility is improved by adding colors other than red (R), green (G) and blue (B), but an example of using three colors R, G and B (RGB phosphors) is used for the following description.

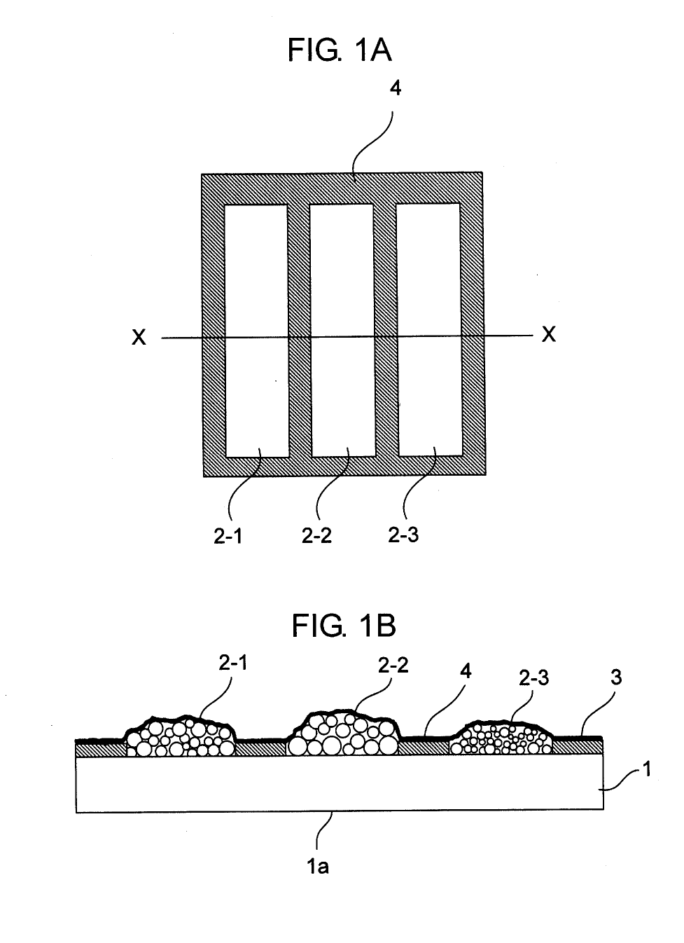

An example of a configuration of a light-emitting substrate according to the present invention is described. FIG. 1A is a diagram depicting a minimum unit portion of the three types of phosphors disposed on a flat surface of the substrate, and FIG. 1B is cross-sectional view sectioned at the X-X line in FIG. 1A.

The illustrated light-emitting substrate has a light transmissive substrate 1, three color phosphors, 2-1, 2-2 and 2-3, disposed on the substrate 1, and a metal back layer 3 which covers these phosphors. A black matrix 4 is disposed around each phosphor. In the illustrated example, a stripe type black matrix is disposed, but various shapes of black matrix can be disposed according to necessity.

A black matrix is disposed to prevent a wraparound to adjacent phosphors even if the irradiation position of the electron beam is somewhat deviated, or to avoid a drop in display contrast by preventing the reflection of external light. Therefore the black matrix can be constituted by a material which satisfies at least one of these functions. The black matrix can be formed by a known method, such as a screen printing method using a black material and ink containing binder, for example. For the black material, graphite can be used as a main component. A material other than graphite may be used instead.

The black matrix may have conductivity to prevent a charge up by electron beams. The black matrix includes, for example, carbon, chromium, cobalt, titanium, ruthenium or a compound thereof, and is not restricted to a specific material if only visible light reflectance is low.

In the illustrated example, phosphor 2-1 which emits red (R), phosphor 2-2 which emits green (G) and phosphor 2-3 which emits blue (B), are formed in the black matrix 4, and each phosphor is separated by the black matrix 4. The disposed area of each phosphor can be used as a pixel or sub-pixel in the image display.

A set of three colors, red, blue and green, is called a “pixel”, which is the minimum unit for color display, and each cell of red, blue and green may be called a “sub-pixel” in some cases. An area of one pixel is determined by a number of pixels and the size of the display.

The substrate 1 is light transmissive, to transmit light from each phosphor required for an image display. For this light transmissive substrate, a substrate using such material as quartz glass, soda-lime glass, non-alkali glass and high strain point glass (e.g. PD200 made by Asahi Glass Co., Ltd.) can be used. High strain point glass is especially preferable since strain during thermal treatment processing, in manufacturing steps, hardly occurs.

For the red phosphor 2-1, Y₂O₃:Eu³⁺ or Y₂O₂S:EU³⁺, for example, can be used. For the green phosphor 2-2, ZnS:Cu, Al, SrGa₂S₄:Eu²⁺, for example, can be used. For the blue phosphor 2-3, ZnS:Ag or CaNgSi₂O₆:Eu²⁺, for example, can be used. This sequence and arrangement of each phosphor need not follow the illustrated sequence. Each phosphor can be formed by securing a layer of fluorescent material particles on a predetermined area on the substrate. For the fluorescent material, it is preferable to select a particle diameter (average particle diameter) according to the design of the light-emitting substrate.

A preferable particle diameter of the fluorescent material constituting each phosphor differs depending on the penetration length of the electrons irradiated onto the phosphor, but it is preferable that the average particle diameter is in a range of not less than 0.5 μm and not more than 20 μm. For each phosphor, a material for forming phosphor containing fluorescent material and binder is prepared, and a predetermined structure (size) of phosphor is formed on a predetermined area on the substrate by a screen printing or photolithography method. The thickness of each phosphor is preferably about 1 μm to 40 μm, considering the utilization efficiency of the electron beam and light, although this depends on the particle diameter of the fluorescent material contained in the phosphor.

It is preferable to form a member for absorbing light having a wavelength other than the emission wavelength of the phosphor between each phosphor and the substrate 1, since this improves contrast.

Processing for improving the adhesive strength between fluorescent materials constituting each phosphor, and between fluorescent material and the substrate may be performed if necessary. For this processing to improve adhesive strength, a method of supplying a dispersed solution, in which such adhesive material as silica particles are dispersed in a solvent, to the phosphors by a spray method or spin coat method and drying the dispersed solution, can be used.

In the present invention, the light reflectance difference is created by setting the light reflectance of the portion of the metal back layer 3 covering the phosphor having the lowest E/L ratio among the phosphors 2-1, 2-2 and 2-3, to be higher than that of the portion covering the other phosphors. Various methods can be used to create the light reflectance difference. In particular, it is preferable to create a light reflectance difference by changing the surface roughness on the surface at each phosphor side of the metal back layer 3.

The surface roughness of the metal back layer 3 is specified by the arithmetic average roughness Ra. Ra is a value generated by extracting a reference length portion from the roughness curve in the direction of the average line thereof, totaling the absolute values of the deviations from the average line of the extracted portion to the measured curve, and averaging the total.

The reflected light is either by regular reflection or by diffuse reflection. The light reflectance of the metal back layer is specified by the total light reflectance including both regular reflection and diffuse reflection. The light reflectance at the emission wavelength of the phosphor is related to the light utilization efficiency, so it is preferable to measure the light reflectance at the peak wavelength of the emission.

Now a method of creating the light reflectance difference using surface roughness will be described.

First in the structure shown in FIG. 1B, a phosphor having the lowest E/L ratio is selected out of the phosphors 2-1, 2-2 and 2-3, which are light-emitting members. Hereafter a method of manufacturing a light-emitting substrate will be described using an example of a case when the E/L ratio of the blue phosphor 2-3 is the lowest.

In a stage of forming each phosphor, a blue phosphor 2-3 is formed to be thinner than the other phosphors 2-1 and 2-2, in a range of design to obtain the target luminance and chromaticity.

For the particle of the fluorescent material contained in each phosphor, the surface roughness of the metal back layer on the phosphor having the lowest E/L ratio can be relatively low if the particle diameter (e.g. average particle diameter) of the fluorescent material contained in the phosphor having the lowest E/L ratio is lower than the fluorescent materials contained in the other phosphors, then the effect of decreasing surface roughness can be further improved due to the effect of filling a resin member for smoothing, which is mentioned later.

In the state of each phosphor being formed with adjusting thickness thereof as mentioned above, a resin member for smoothing is supplied to phosphors on the surface of the substrate 1, and selectively smoothing the surface by filling the smoothing resin member between particles constituted by fluorescent materials on the surface of the blue phosphor 2-3.

For the smoothing processing, a method of preparing liquid material for filling the resin member and supplying it onto the substrate by an inkjet method, spray method, spin coat method or the like can be used. In this case, conditions to supply the liquid material are adjusted so that the surface of the blue phosphor 2-3 selectively becomes a smooth surface.

For the liquid material, various materials can be used only if the state of the resin member being filled between particles of fluorescent materials can be created, and this resin material can be burned and removed after the metal back layer 3 is formed, or preferably can be decomposed at low temperature. For example, material for smoothing used for filming processing can be used. For the resin member, such resin as acrylic resin or urethane resin can be used. For the liquid material, a resin emulsion, which contains resin particles, such as acrylic resin and urethane resin, being dispersed in a solvent, such as a water medium, and which can easily solidify [the resin particles] by heating and drying, can be suitably used.

It is preferable that the resin member is filled up to a position approximately matching the average position of the surface (average thickness) of the blue phosphor 2-3. In other words, the resin member may be filled up to a position 5 μm or less higher than the average position of the surface of the blue phosphor 2-3. If the layer of resin member is formed on the surface of the blue phosphor 2-3 and the thickness thereof exceeds 5 μm from the average position of the surface of the blue phosphor 2-3, the metal back layer may peel by blistering. The resin member in the blue phosphor 2-3 may be filled up to a lower position than the average position of the surface of the blue phosphor 2-3 within a range of the length corresponding to the particle diameter (e.g. average particle diameter) of the fluorescent material to the substrate 1 side. If the resin member filling position is formed to be low, exceeding the length corresponding to the particle diameter of the fluorescent material, a smooth surface having a target low surface roughness may not be obtained by the influence of bumps formed because of the particle form of the fluorescent material which appear on the surface of the phosphor.

As described above, selective smoothing of the surface of the blue phosphor 2-3 can be easily implemented by forming the thickness (e.g. average thickness) of the blue phosphor 2-3 having the lowest E/L ratio to be thinner than the thickness (e.g. average thickness) of the other phosphors 2-1 and 2-2. In other words, the surface roughness of the portion on the blue phosphor 2-3 of the metal back layer 3 can be smaller than the surface roughness of the portions of the other phosphors 2-1 and 2-2. As a result, the light which is reflected by the metal back layer 3 and emitted onto the image display surface 1a at the opposite side of the substrate 11, out of the light emitted from the blue phosphor 2-3 having the lowest E/L ratio, can be effectively used, and luminance of white can be increased while maintaining the target chromaticity.

The structure of the light-emitting substrate of the present invention and the manufacturing method thereof were described above, regarding the blue phosphor 2-3 as the phosphor having the lowest E/L ratio, but the light-emitting substrate can be manufactured in the same manner in the case of red phosphor 2-1 or green phosphor 2-2 having the lowest E/L ratio. In the case of using two colors or four or more different colors as well, the light-emitting substrate can be manufactured according to the same steps by selecting a phosphor having the lowest E/L ratio.

On the substrate 1 on which the surface of the phosphor having the lowest E/L ratio is selectively smoothed, the metal back layer 3 is formed using an electron beam (EB) deposition method, for example, and the resin member filled for smoothing is baked and decomposed, whereby the light-emitting substrate is obtained.

The metal back layer 3 has a function to improve the light utilization efficiency by reflecting the light emitted from the phosphor to the image display surface 1a side (opposite surface, from the side where phosphors are disposed, of the light transmissive substrate) of the light-emitting substrate. In the present invention, the light reflectance on the phosphor having the lowest E/L ratio is set to be higher than those on the other phosphors, so that the light utilization efficiency of the phosphor having the lowest E/L ratio is relatively improved, whereby the effect of this invention is implemented.

The metal back layer 3 also has a role of an anode to which high voltage is applied when the electron beam is irradiated onto the phosphors in the case of using the electron beam as emission energy, and a role to prevent charge in the phosphors. Therefore for a material of the metal back layer 3, conductive metal material, such as Al, which satisfies the conditions including high electron beam transmittance and high light reflectance is desirable. For the thickness of the metal back layer 3, an optimum value can be selected depending on the electron acceleration voltage, but a film thickness of about 100 nm is preferable in terms of the relationship of the light reflectance of the metal back layer 3 and the electron beam shielding effect.

The light-emitting substrate according to the present invention can be suitable used for a component of an image display panel of an image display apparatus which displays images by applying energy for each phosphor to emit light.

Now an example of applying the light-emitting substrate according to the present invention to an FED panel will be described.

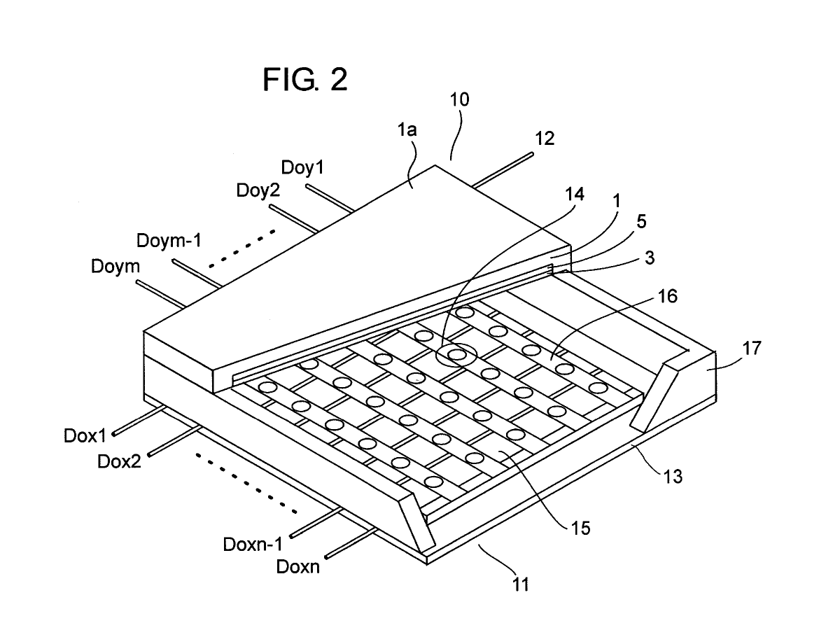

An FED panel shown in FIG. 2 as an electron beam excitation type image display apparatus has a structure where a face plate 10 and a rear plate 11 are bonded via a side wall 17, so that an internal space sealed by these members is created. This internal space is vacuumed to be approximately 10⁻⁵ Pa or less, for example, which is required for image display.

The face plate 10 has the above mentioned configuration of a light-emitting substrate which has a light transmissive substrate 1, fluorescent surface 5 and metal back layer 3, and constitutes an image display surface 1a (outer surface of the light-emitting substrate).

The rear plate 11 has a substrate 13 at the rear plate side, electron-emitting devices 14 disposed on the substrate 13, and wiring 15 and 16 for applying electric signals, for emitting electrons, to the electron-emitting devices 14.

For the electron-emitting devices 14, a surface-conduction electron-emitter (SCE), Spindt type field-emitting device, metal/insulator/metal (MIM) type electron-emitting device or a device using a carbon nanotube (CNT) as an electron-emitting element can be used. In particular, a surface conduction electron-emitter device, which can be easily fabricated, can be suitably used for the electron-emitting device of the image display apparatus of the present invention.

In the illustrated example, an x direction wiring is constituted by a wiring 15, and an input terminal Dox1 to Doxn is formed in each wiring. A y direction wiring is constituted by a wiring 16, and an input terminal Doy1 to Doym is formed in each wiring. These wirings 15 and 16 constitute matrix wiring. The electron-emitting device 14 connected to these wirings is formed on an intersection of crossing the x direction wiring 15 and the y direction wiring 16 in an electrically insulated state, or a neighbor point thereof. A scan signal is supplied from the y direction wiring, and a drive signal from a drive circuit (not illustrated) is supplied to the electron-emitting device via the x direction wiring, whereby an electron beam is emitted from the rear plate side. In the case of an image display apparatus using electron-emitting device having a gate electrode, terminals to apply voltage to the gate electrode from the outside are disposed.

A terminal 12 for applying high voltage is connected to the metal back layer 3 of the face plate 10. Because of this configuration, electrons emitted from the electron-emitting devices 14 at the rear plate 11 side can be effectively guided to the face plate 10 side, using the metal back layer 3 as an anode where high voltage (acceleration voltage) is applied, and the electron-emitting device 14 as a cathode.

The substrate 13 in the rear plate 11 side is constituted by such material as quartz glass, soda-lime glass, non-alkaline glass and high strain point glass (e.g. PD200 made by Asahi Glass Co., Ltd.). For the material of the substrate 13, high strain point glass, which does not strain much during thermal treatment processing in manufacturing steps, is particularly preferable.

The electron beam emitted from the electron-emitting device 14 is irradiated onto phosphor (not illustrated) disposed corresponding to the electron-emitting device 14 via the metal back layer 3. Thereby the phosphor emits light, and an image is displayed on the image display surface 1a of the face plate 10.

According to the image display apparatus of the present invention, the luminance of white can be improved while maintaining a desired white color.

### Example 1

For the light transmissive substrate, a glass substrate (PD200 made by Asahi Glass Co., Ltd.) of which thickness is 2.8 mm is used, where material for a black matrix (NP-7803D made by Noritake Kizai Co., Ltd.) is screen-printed, and patterning is performed using a photolithography method to form a black matrix on the substrate.

Then phosphors corresponding RGB shown in FIG. 1B are formed. For the fluorescent materials, Y₂O₂S:Eu (average particle diameter: 6.5 μm) made by Kasei Optonix, Ltd. is used for the red phosphor, SrGa₂S₄:Eu (average particle diameter: 6.8 μm) made by Kamioka Mining & Smelting Co., Ltd. is used for the green phosphor, and CaMgSi₂O₆:Eu (average particle diameter: 2.7 μm) made by Tokyo Kagaku Kenkyusyo Co., Ltd. is used for the blue phosphor.

When each phosphor is formed using these fluorescent materials, the ratio of luminance of each phosphor required for emitting white with chromaticity (x, y)=0.313, 0.329) is set to approximately R:G:B=2:7:1. The ratio of luminous efficiency of each phosphor is approximately R:G:B=3:14:1. In other words, the E/L ratio is approximately R:G:B=1.5:2:1. Therefore the reflectance of the metal back layer on the blue phosphor having the lowest E/L ratio is set to be greater than the reflectance of the metal back layer on the other phosphors.

Then butyl carbitol acetate and ethylcellulose are mixed to obtain binder. The obtained binder and red fluorescent material are mixed to prepare paste for the red phosphor. The paste for green phosphor and the paste for blue phosphor are also prepared in the same manner.

Each paste is individually supplied to the opening of the black matrix by the screen printing method, and is oven-dried at 80° C. for 15 minutes, so as to form a fluorescent material layer having a predetermined thickness. The thickness of each fluorescent material layer is about double that of the average particle diameter of the used fluorescent material.

Then the resin component contained in each fluorescent material layer is decomposed and removed by oven-baking at 450° C. for 60 minutes.

Then colloidal silica (IPA-ST made by Nissan Chemical Industries, Ltd.) is coated by a spin coat method, and oven-dried at 100° C. for 10 minutes to obtain each phosphor. The colloidal silica is coated to reinforce adhesion of the fluorescent material.

Acrylic resin, a smoothing material, is coated as an emulsion on the entire surface of the substrate, where the black matrix and phosphors are disposed, by spin coating, so that the surface of the blue phosphor becomes smooth. At this time, the emulsion is coated such that the acrylic resin is filled down to the average position on the surface of the blue phosphor after heating and drying processing. Then an oven-heat treatment is performed at 120° C. for 10 minutes. By this processing, the surface of the blue phosphor is selectively smoothed.

Then Al is formed to be a 100 nm film thickness by an EB deposition method, and is baked at 450° C. for 60 minutes to decompose and remove the acrylic resin, whereby the metal back layer is formed. The surface roughness Ra of the metal back layer is measured by a laser microscope (made by Olympus), and the light reflectance of the metal back layer is measured by a spectrocolorimeter (made by Konica Minolta). As a result, the surface roughness of the surface of the metal back layer on the blue phosphor, which contacts the blue phosphor, is Ra=0.2 μm, and the light reflectance is 80% at a 450 nm wavelength. The surface roughness of the surface of the metal back layer on the red phosphor, which contacts the red phosphor, is Ra=1.2 μm, and the light reflectance is 70% at a 630 nm wavelength. The surface roughness of the surface of the metal back layer on the green phosphor, which contacts the green phosphor, is Ra=1.5 μm, and the light reflectance is 68% at a 530 nm wavelength.

For the surface roughness Ra, the surface profile of the metal back is detected by a laser microscope, with irradiating light from the phosphor side of the metal back, and the surface roughness Ra is calculated regarding the reference length as 30 μm, which is smaller than a pixel and greater than a particle diameter of the phosphor.

Finally Ti is formed for 500 nm as a getter by EB deposition, and the light-emitting substrate is obtained.

An FED panel having the structure shown in FIG. 2 is fabricated using this light-emitting substrate as a face plate, and inside of the FED panel is vacuumed to a predetermined vacuum state using the getter. The luminance of each phosphor is measured by the spectro-radiometer SR-3 (made by Topcon Technohouse Corporation), and the luminous efficiency is calculated. As a result, it was confirmed that the luminous efficiency of the blue phosphor alone is improved by an increase of light reflectance of the metal back layer.

When white is displayed on this FED panel, the reflectance of the metal back layer on the blue phosphor, which is a phosphor having the lowest luminous efficiency, is improved more so than the light reflectance of the metal back layer on the other phosphors. This means that the luminance of white can be improved, since the luminance of the blue light can be improved, and the luminance of red and green lights, which are conventionally restricted in luminance adjustment so that the ratio of luminous efficiency of each color becomes the one demanded to obtain a desired white, can be improved.

### Example 2

An FED panel is fabricated in the same manner as Example 1, except that the combination of the following fluorescent materials is used.
For red phosphor:
   Y₂O₂S:Eu by Kasei Optonix, Ltd. (average particle diameter: 4.0 μm)
For green phosphor:
   ZnS:Cu, Al by Kasei Optonix, Ltd. (average particle diameter: 8.2 μm)
For blue phosphor ZnS:Ag by Kasei Optonix, Ltd. (average particle diameter: 4.0 μm)

With the combination of the above fluorescent materials, the ratio of the luminance of each phosphor required for emitting white with chromaticity (x, y)=(0.313, 0.329) is approximately R:G:B=2:7:1. The ratio of luminous efficiency of each phosphor is approximately R:G:B=4:7:1.3. In other words, the E/L ratio of each phosphor is approximately R:G:B=2:1:1.3. Therefore in this example, the reflectance of the metal back layer on the green phosphor having the lowest E/L ratio is set to be higher than the reflectance of the metal back layer on the other phosphors. For the thickness of the fluorescent material layer for forming each phosphor, it is adjusted so that green becomes the thinnest, that is about double the average particle diameter of the fluorescent material, while thickness approximately triples the average particle diameter of the fluorescent material in the case of red and blue.

The surface roughness and light reflectance of the metal back layer on each phosphor measured in the same manner as Example 1 are as follows.
On green phosphor: surface roughness Ra=0.25 μm, light reflectance at a 530 nm wavelength=77%
On blue phosphor: surface roughness Ra=1.2 μm, light reflectance at 440 nm wavelength=70%
On red phosphor: surface roughness Ra=1.2 light reflectance at 630 nm wavelength=70%
   After the same evaluation as Example 1, it was confirmed that the luminous efficiency of green is improved by the metal back.

According to the result of this example, the light reflectance of the metal back layer on the green phosphor, which is a phosphor having the lowest E/L ratio, can be improved compared to the light reflectance of the metal back on the other phosphors. This means that the luminance of white can be improved, since the luminance of the green light can be improved, and the luminance of red and blue light, which are conventionally restricted in luminance adjustment so that the ratio of the luminous efficiency of each color becomes the one demanded to obtain a desired white, can be improved.

### Comparative Example

An FED panel is fabricated in the same manner as Example 2, so that the following surface roughness and light reflectance of the metal back layer are implemented.
On green phosphor: surface roughness Ra=1.5 μm, light reflectance=65%
On blue phosphor: surface roughness Ra=0.2 μm, light reflectance=80%
On red phosphor: surface roughness Ra=0.2 μm, light reflectance=80%
   In this comparison example, an improvement of the luminance of white in Example 2 is not observed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-285199, filed on Dec. 16, 2009, which is hereby incorporated by reference herein in its entirety.

What is claimed is:

1. A light-emitting substrate, comprising on a light transmissive substrate:
a plurality of phosphors which emit different colors by receiving an irradiated electron beam; and
a metal back layer covering these phosphors, wherein white can be generated by different colors obtained by the emission of the phosphors, and
a light reflectance difference is created by setting a reflectance, on the phosphor side, of the metal back layer on a phosphor having a lowest E/L ratio, which is a ratio of luminance (L) and luminous efficiency (E) when white is generated, to be higher than those of the metal back layer on the other phosphors.

2. The light-emitting substrate according to claim 1, wherein
the phosphors are a red phosphor for emitting red, a blue phosphor for emitting blue, and a green phosphor for emitting green.

3. The light-emitting substrate according to claim 1, wherein the light reflectance difference is created by setting a surface roughness of the surface of the metal back layer on the phosphor having the lowest E/L ratio at the phosphor side to be lower than those of the metal back layer on the other phosphors.

4. The light-emitting substrate according to claim 1, wherein an average particle diameter of fluorescent material contained in the phosphor having the lowest E/L ratio is smaller than average particle diameters of fluorescent material contained in the other phosphors.

5. An electron-beam excitation image display apparatus, comprising:
a rear plate having a plurality of electron-emitting devices; and
a face plate on which phosphors, which emit light by irradiation of electrons emitted from the electron-emitting devices, are disposed, wherein
the face plate is the light-emitting substrate according to claim 1.

6. A method of manufacturing a light-emitting substrate which has, on a light transmissive substrate, a plurality of phosphors which emit different colors by receiving irradiated electrons, and a metal back layer covering these phosphors, and can generate white by different colors from the plurality of phosphors,
the method comprising steps of:
forming a plurality of phosphors for emitting different colors which can generate white on the light transmissive substrate;
filling a resin member in a surface of a phosphor having a lowest E/L ratio, which is a ratio of the luminance (L) and luminous efficiency (E) when white is generated so as to smooth the surface; and
forming a metal back layer for coating the plurality of phosphors including the phosphor in which the resin member is filled, wherein
in the step of filling the resin member in the surface of the phosphor having the lowest E/L ratio for smoothing the surface, fluorescent material layer of the phosphor having the lowest E/L ratio is formed so that thickness thereof is less than that of the other phosphors, and the resin member is filled down to the surface of the fluorescent material layer of the phosphor having the lowest E/L ratio, whereby the surface of the phosphor having the lowest E/L ratio becomes smoother than the surface of the other phosphors, and a light reflectance difference is created so that a light reflectance of the metal back layer on the phosphor having the lowest E/L ratio on the phosphor side is higher than those of the metal back layer on the other phosphors.

7. The method of manufacturing the light-emitting substrate according to claim 6, wherein an average particle diameter of the fluorescent material contained in the phosphor having the lowest E/L ratio is smaller than average particle diameters of the fluorescent material contained in the other phosphors.
